(19) United States
(12) Patent Application Publication
(10) Pub. No.: US 2009/0032065 A1
(43) Pub. Date: Feb. 5, 2009

(54) SYRINGE WASH STATION FOR ANALYTICAL APPLICATIONS

(76) Inventors: Daniel L. Bantz, Brookline, NH (US); Thomas R. Londo, Ashland, MA (US); Paul M. Grippo, Bedford, NH (US); Frank Sylva, Tewksbury, MA (US)

Correspondence Address: DON W. BULSON (PARK);RENNER, OTTO, BOISSELLE & SKLAR, LLP, 1621 EUCLID AVENUE / 19TH FLOOR, CLEVELAND, OH, 44115, US

(21) Appl. No.: 12/096,712

(22) PCT Filed: Dec. 8, 2006
(86) PCT No.: PCT/US06/61804

§ 371 Date: Jun. 9, 2008

Related U.S. Application Data
(60) Provisional application No. 60/748,398, filed on Dec. 8, 2005.
(60) Provisional application No. 60/821,147, filed on Aug. 2, 2006.

(51) Int. Cl. B08B 9/027; B08B 13/00

(52) U.S. Cl. 134/22.12; 134/116; 134/166 C

(57) ABSTRACT

An apparatus and method that address carry-over and contamination resulting from incomplete washing/flushing of syringe surfaces routinely exposed to samples and/or reagents. Specifically, the apparatus and method provide for washing the interior of a syringe barrel as well as interior and exterior surfaces of a syringe needle.

### RELATED APPLICATIONS

This application claims the benefit of U.S. Provisional Application Nos. 60/748,398 filed Dec. 8, 2005 and 60/821,147 filed Aug. 2, 2006, which are hereby incorporated herein by reference in their entireties.

### FIELD OF THE INVENTION

The invention herein described relates generally to liquid handling systems and devices, and particularly those used in liquid chromatography or other analytical systems, and more particularly to syringe wash stations for use in such systems.

### BACKGROUND

Many nuclear, chemical, and biological reactions require exact adherence to reaction stoichiometry when setting them up. Failure to establish the proper ratio among the reactants can lead to incomplete and/or incorrect reaction intermediates and products. Depending on the reaction, failure to control the rate of introduction or amounts of reactants and samples can sometimes lead to undesirable results.

To a large extent, the ability to control the reaction is directly related to the ability to accurately and precisely aspirate and dispense correct amounts of each constituent at the appropriate rate. In many situations, the devices of choice to accomplish this are accurate and precise but expensive automated syringes or pipettes (herein collectively referred to as syringes). For economic reasons, the syringes are used multiple times. Consequently, they must be cleaned between uses to prevent remnant carry-over that can negatively impact the results of subsequent analyses.

Carry-over/contamination can still arise from incomplete cleaning/flushing to waste of surfaces routinely exposed to samples and other contaminants. Incomplete cleaning can arise from unswept areas in the sample flow path, and uncleaned areas in the sampling path that only occasionally, through statistical incidence, come in contact with sampling elements. Some of the causes are insidious and only exhibit themselves sporadically over the course of several runs while others are more obvious and demonstrate themselves routinely from run to run.

Several syringe washing techniques have been used. One technique uses disposable tips. In this case, the syringe is designed such that the costly elements are retained for multiple uses, but any portion that is wetted by reagents or solvents can be detached and thrown away. This approach is adequate for several applications and is widely used for most manual operations within the laboratory environment. The utility of this approach, however, declines for automated operation since it is difficult to attach new disposable elements with precise alignment. While human beings can readily compensate for slightly misaligned tips during manual operation, it is very difficult for robotic devices to do the same. Costs are exceedingly high to engineer robotic systems to precisely attach disposable elements or to compensate for misaligned tips. These costs generally far exceed the cost of applying syringe or pipette cleaning mechanisms to the automated systems. Moreover, disposable elements tend to take up valuable robotic deck space causing the automation aspect to become larger to compensate and thus become even more expensive.

Another cleaning technique uses the syringe itself. In this case, after dispensing or injecting, the syringe's barrel is washed internally and its probe is washed both internally and externally by repetitive aspiration and dispensation of wash solution. A major disadvantage of this method is that several aspirate and dispense cycles are typically required to achieve the desired level of cleanliness, thus making this method exceedingly slow. One must cycle between aspirating wash solution from a reservoir location and expelling it into a waste location. This causes excessive wear and tear on robotic motion mechanisms in the case of automated systems. The many actuations required to clean the syringe also reduces its lifetime.

Still another cleaning technique uses a dedicated wash line connected directly to the syringe or pipette barrel. The wash line connects into the device such that the fluid flows through the barrel and out of the open end of the syringe needle. If the syringe needle is situated within a vertically standing dead-ended tube or cylinder, the effluent from the device flows back up the tube and around the outer surface of the needle thus cleaning the outer aspect of that element as well (see FIG. 1). This approach is much faster than using the syringe or pipette device itself as described above. The wash solution can be pumped through the device at an elevated rate to reduce the washing time. In addition, the number of syringe actuations is reduced and thus provides longer syringe life. Also, internal and external aspects can be cleaned simultaneously thus eliminating the need to transport the device (automatically or manually) between a wash reservoir and a waste station. A significant drawback, however, is that the dedicated wash solvent tubing is bulky, gets in the way, can leak, and can tangle up with other lines and connections during operation.

### SUMMARY OF THE INVENTION

The present invention provides an apparatus and method that address carry-over and contamination resulting from incomplete washing/flushing of syringe surfaces routinely exposed to samples and/or reagents. Specifically, the apparatus and method provide for washing the interior of a syringe barrel as well as interior and exterior surfaces of a syringe needle.

In a preferred embodiment, a stand-alone syringe wash station according to the invention provides quick, hands-free fluidic service to syringes used in laboratory operations. The barrel of the syringe is washed internally and the needle is washed both internally and externally by aspiration and dispensation of wash solution. Several aspirate and dispense cycles may be needed to achieve a desired level of cleanliness, but without the need to repetitively shuttle the syringe between a cleaning solvent reservoir and a contaminated solvent disposal station as was done in prior art automated systems. Instead, those tasks can be accomplished in one location without the need for moving the syringe.

Accordingly, the invention provides a syringe wash station for cleaning a syringe used in a liquid handling system such as a liquid chromatography system, the syringe including a needle communicating with a barrel in which a plunger is movable for dispensing or aspirating a fluid through a distal open end of the needle. The wash station comprises an interior needle wash chamber having a lower end and an open upper end into which the needle of the syringe can be axially inserted; an overflow chamber extending vertically above the open upper end of the needle wash chamber; a wash port opening to a side wall of the needle wash chamber for supplying a cleaning fluid to the interior chamber; a drain connected to the lower end of the needle wash chamber; and a valve for opening and closing the drain respectively to permit and block fluid flow through the drain. When the valve is closed, fluid flowing from the wash port into the needle chamber can fill and flow through the needle wash chamber for replenishing the needle wash chamber with clean fluid for drawing into the and cleaning the interior of the syringe, and for cleaning the exterior surface of the needle and then overflowing the upper end of the needle wash chamber for flow into the overflow chamber and subsequent discharge. When the valve is open, the cleaning fluid in the chamber and solution dispensed from the syringe can flow from the needle wash chamber through the drain for discharge.

In a particular embodiment, the drain may open to the needle wash chamber below the wash port, and the wash port may open to the side wall of the needle wash chamber below the upper end of the needle wash chamber.

The needle wash chamber may be formed by a first tubular member, and the overflow chamber may be formed between the first tubular member and a larger diameter second tubular member that surrounds but is radially spaced from the first tubular member.

The needle wash chamber may have a diameter at least twice the diameter of the needle for flow of fluid around the exterior of the needle for cleaning the exterior surface.

A holder is provided for holding the syringe with the needle thereof inserted into the needle wash chamber.

The holder may include a syringe interface device for establishing communication between the wash station controller and the syringe, whereby commands can be received from the syringe or issued to the syringe by or from the wash station controller.

According to another aspect of the invention, there is provided a method of cleaning a syringe used in a liquid handling system such as a liquid chromatography system, wherein the syringe includes a needle communicating with a barrel in which a plunger is movable for dispensing or aspirating a fluid through a distal open end of the needle. The method comprising the steps of: (a) axially inserting the syringe through an open upper end of an axially extending needle wash chamber at a wash station; (b) flowing cleaning fluid through a wash port opening in a side wall of the needle wash chamber between upper and lower ends of the needle wash chamber; (c) closing the drain to cause cleaning fluid to fill the needle wash chamber and flow out through an open upper end of the needle wash chamber into an overflow chamber; (d) opening the drain to allow the cleaning fluid in the needle wash chamber to flow out through a drain; (e) retracting the plunger of the syringe during step (c) to draw cleaning fluid through the needle and into the barrel of the syringe; and (f) extending the plunger of the syringe during step (d) to discharge the cleaning fluid from the barrel of the syringe through the needle and into the fluid flowing from the needle wash chamber to the drain.

In particular, the cleaning fluid may drain by gravity through the drain when the valve is open, or be assisted by a vacuum device.

Typically, steps (b) through (f) will be repeated multiple times to obtain a desired level of cleanliness.

Usually at least 20% to 75% or more of the length of the needle may be inserted into the needle wash chamber.

The needle may be held spaced from the side wall of the needle wash chamber when inserted into the wash chamber for cleaning the outer surface of the needle.

According to further aspect of the invention, there is provided a syringe wash station for cleaning a syringe used in a liquid handling system such as a liquid chromatography system, the syringe including a needle communicating with a barrel in which a plunger is movable for dispensing or aspirating a fluid through a distal open end of the needle, and a side port communicating with the barrel. The syringe wash station comprises a body defining an axially extending interior chamber into which the syringe can be axially inserted, and a wash port opening to a side wall of the interior chamber for supplying a cleaning fluid to the interior chamber; and a pair of annular seals axially spaced apart and located on opposite sides of the wash port for sealing against an exterior surface of the syringe at opposite sides of the side port of the syringe.

A holder may be provided for receiving and holding the syringe such that the side port of the syringe will be located in the region of the interior chamber located between the annular seals.

According to yet another aspect of the invention, there is provided a method of cleaning a syringe used in a liquid handling system such as a liquid chromatography system, wherein the syringe the syringe includes a needle communicating with a barrel in which a plunger is movable for dispensing or aspirating a fluid through a distal open end of the needle, and a side port communicating with the barrel. The method comprising the steps of: axially inserting the syringe into an axially extending interior chamber of a wash station with the side port located in a region bounded by a pair of annular seals axially spaced apart and located on opposite side of a wash port for sealing against an exterior surface of the syringe at opposite sides of the wash port; retracting the plunger of the syringe such that it is located on a side of the side port remote from the distal end of the needle; and flowing a cleaning fluid through the wash port and into the interior chamber, whereupon such fluid will flow through the side port into the barrel of the syringe and out through the distal end of the needle, thereby cleaning interior surfaces of the syringe.

Further features of the invention will become apparent from the following detailed description when considered in conjunction with the drawings.

### BRIEF DESCRIPTION OF THE DRAWINGS

In the annexed drawings,

FIG. 1 is a perspective view of an exemplary stand-alone syringe wash station according to the invention, with a syringe shown inserted therein for cleaning;

FIG. 2 is a cross-sectional view of the syringe wash station of FIG. 1, with the syringe removed;

FIG. 3 is a cross-sectional view similar to FIG. 1, but with the syringe held in the station;

FIG. 4 is an enlargement of an upper end portion of FIG. 3;

FIG. 5 is an enlargement of a lower end portion of FIG. 3;

FIGS. 6A-6E are a series of views schematically illustrating a cleaning operation using the syringe wash station of FIG. 1;

FIG. 7 is a perspective view of another exemplary stand-alone syringe wash station according to the invention, with a syringe shown inserted therein;

FIG. 8 is a cross-sectional view of the syringe wash station of FIG. 7, with a portion thereof shown enlarged; and

FIG. 9 is a cross-sectional view similar to FIG. 3, modified to include features of the wash station shown in FIGS. 7 and 8.

### DETAILED DESCRIPTION

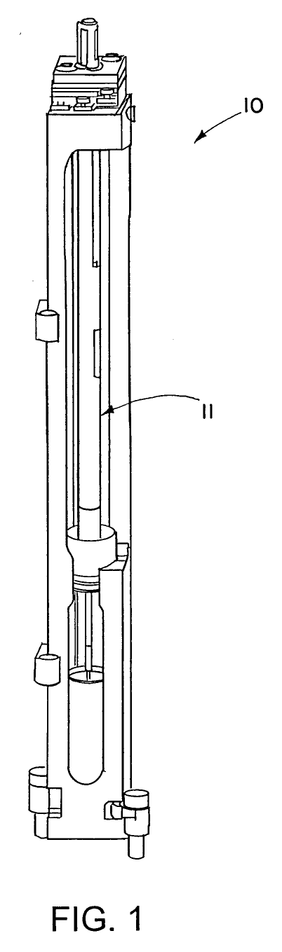

Referring now in detail to the drawings and initially to FIGS. 1-3, an exemplary syringe wash station for cleaning a syringe used in a liquid handling system, such as a liquid chromatography or other analytical system, is indicated generally by reference numeral 10. The syringe, generally indicated by reference numeral 11, includes a needle 12 communicating with a barrel 13 in which a plunger (not shown) is movable for dispensing or aspirating a fluid through a distal open end of the needle. The reference to a syringe herein encompasses syringes, pipettes and other types of sampling probes.

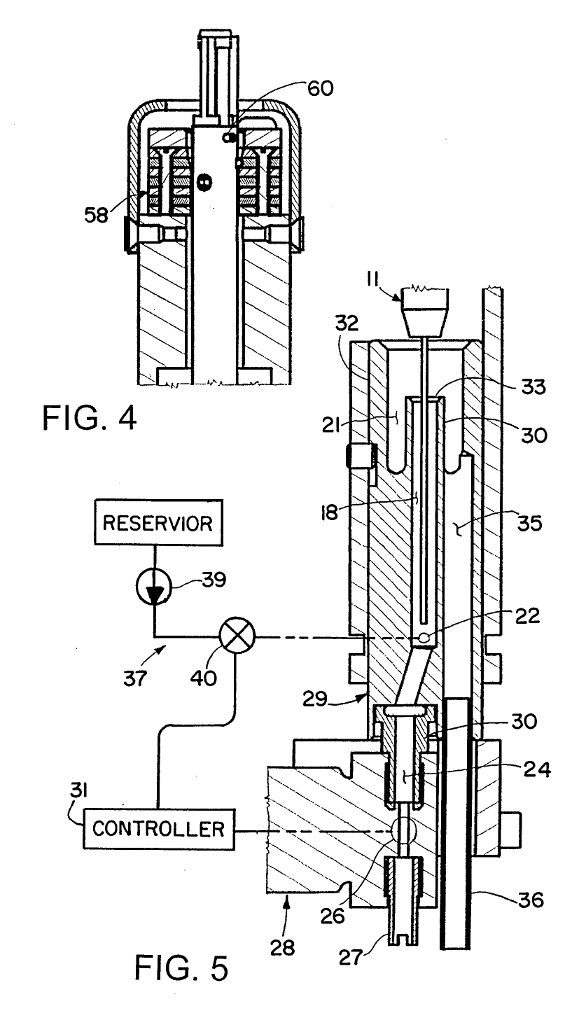

The illustrated syringe wash station 10 is a stand-alone assembly or unit. With additional reference to FIGS. 4 and 5, the wash station 10 can be seen to generally comprise an interior needle wash chamber 18 having a lower end and an open upper end into which the needle 12 of the syringe can be axially inserted; an overflow chamber 21 extending vertically above the open upper end of the needle wash chamber 18; a wash port 22 opening to a side wall of the needle wash chamber for supplying a cleaning fluid to the interior chamber; a drain 24 connected to the lower end of the needle wash chamber 18; and a valve 26 for opening and closing the drain 24 respectively to permit and block fluid flow through the drain. The drain may be connected to a waste container by a suitable conduit that may be coupled to the fitting 27. Any suitable valve may be used, such as a solenoid operated valve. The valve may be contained in a valve assembly 28 that may be connected to a wash station body 29 by a suitable fitting 30. Operation of the valve may be controlled by a wash station controller 31 included in the wash station as a unit, or if desired, located remotely. While the valve may be controlled by the wash station controller 31, other means may be provided for opening and closing the valve, including manually or by means of other control devices, such as an overall fluid handling system controller.

As shown, an upper end portion of the needle wash chamber 18 may be formed by an inner tubular member 30 which may be formed integrally with the wash station body 29 in which the balance of the wash chamber is formed, or as a separate piece. The overflow chamber 21 is formed between the inner tubular member 29 and a larger diameter outer tubular member 32 that likewise may be formed integrally with the wash station body or as a separate piece. The outer tubular member 32 surrounds but is radially spaced from the inner tubular member 30 to form a lower portion of the overflow chamber. The upper portion of the overflow chamber extends above the upper end or rim 33 of the wash chamber to capture fluid flowing out through the top of the wash chamber. The lower end of the overflow chamber is connected to a drain passage 35 that may be connected to a waste collector by a suitable conduit that may be attached to the lower end of a drain tube 36.

In use, cleaning fluid may be supplied from a source 37 thereof to the wash port 22 for introduction into the wash chamber 18. The fluid source 37 may be controlled by the controller for controlled delivery of cleaning fluid to the wash chamber, or such fluid source may be otherwise controlled, such as manually for some applications. The fluid source may include a reservoir 38 for holding a supply of cleaning fluid, and a pump 39 and/or supply valve 40 operable, for example under the control of the wash station controller, to supply the cleaning fluid under pressure to the wash port.

When the valve 26 is closed (rotated 90° in FIG. 5), fluid flowing from the wash port 22 into the needle wash chamber 18 will fill the needle wash chamber and overflow the upper end of the needle wash chamber where it is captured by the overflow chamber 21. Fluid in the overflow chamber will drain out through the drain 35 for disposal. When the valve is open as shown in FIG. 5, cleaning fluid can flow from the needle wash chamber through the wash chamber drain 24 for disposal.

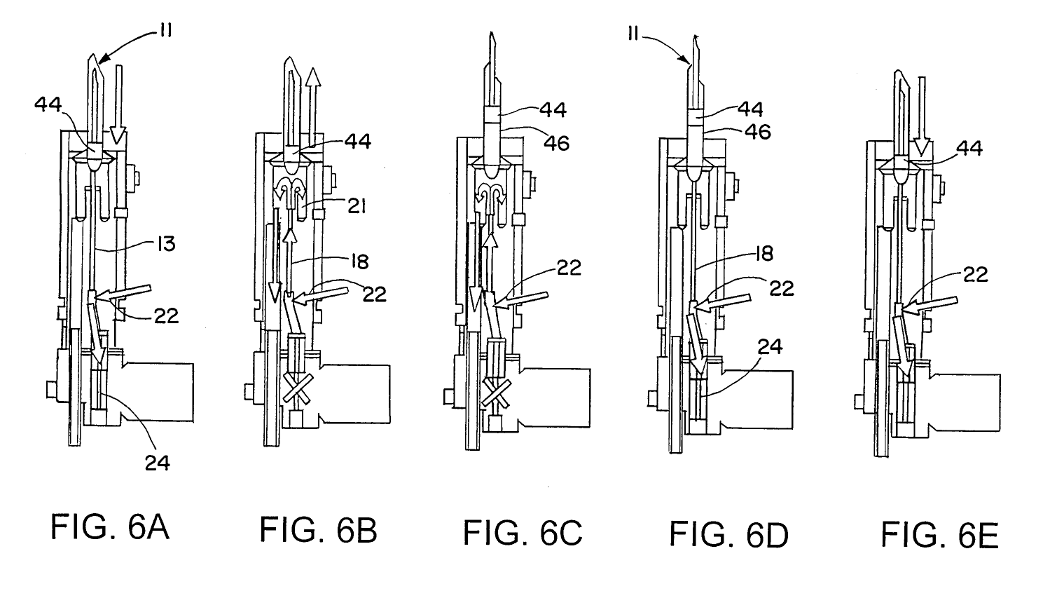

Referring now to FIGS. 6A-6E in conjunction with FIGS. 43 and 5, an exemplary cleaning procedure will now be described. First, the wash chamber drain valve 26 is opened to completely drain the wash chamber 18 to waste if this has not already been done. The syringe 11 is placed into the device 10 such that its needle 12 comes to rest within, but not touching, the wall surrounding the wash chamber 18. The syringe plunger 44 is moved to the fully down position as shown in FIG. 6A to discharge into the wash chamber any contents that may remain in the syringe, such contents then flowing out through the drain 24 of the wash chamber.

Next, the wash chamber drain valve 26 is closed by the wash station controller, such closure being depicted by an “X” in FIGS. 6B and 6C. Cleaning fluid, such as a suitable solvent, is introduced through the wash port 22 into the wash chamber 18. As above mentioned, flow of fluid to the wash port may be controlled by a suitable valve and/or pump that in turn may be controlled by the wash station controller 31. Alternatively or additionally, the supply of fluid may be controlled manually such as by use of a manually operated valve.

The fluid flowing into the wash chamber 18 will fill the wash chamber and overflow into the overflow chamber 21 for passage to waste. This will wash the exterior surface of the syringe needle 13 at the portion thereof that extends below the top end of the wash chamber. At the same time, the syringe plunger 44 can be retracted upwardly to draw clean solvent into the lumen of the needle and into the barrel 46 of the syringe 11 as shown in FIG. 6B.

When the syringe plunger 44 reaches its uppermost designated position, the wash chamber drain valve 26 is again opened to completely drain the wash chamber contents as shown in FIGS. 6C and 6D. The solvent flow into the wash chamber may or may not continue during this step, as desired.

Next the syringe plunger 44 is again extended to the fully down position expelling the contaminated solvent into the lower portion of the wash chamber 18 whereafter if flows through the wash chamber drain 24 to waste as depicted in FIG. 6E.

The above-described steps illustrated by FIGS. 6B through E can be repeated for as many aspirate and dispense strokes as are necessary to achieve the desired cleanliness of the inner and outer surfaces of the syringe needle and syringe barrel.

A significant advantage arises from the fluid drop-out illustrated in FIGS. 6D and 6E. This effectively and “immediately” drains all contaminants from the wash chamber and syringe to waste, preparing the wash chamber to be filled with clean solvent for the next aspiration step. This provides a “step” change in the wash chamber's fluid contamination level similar to that described in Equation 1 below.

$${C}_{t} = \{ \begin{matrix}{C}_{0} ; t \leq {t}_{0} \\ Rs ; t > {t}_{0}\end{matrix} \} \qquad Equation 1$$

where C₀=the contaminant concentration in the wash chamber immediately after dispensation from the dirty syringe; Cₜ=the contaminant concentration in the wash chamber at time=t; Rs=the residual contaminant concentration after the drop out, which results mostly from desorption of analyte previously adsorbed to the walls; t=time; and t₀=the point where the drop-out valve is opened.

Thus, there is provided a fast, minimal solvent intensive, and efficient means for changing the fluid over from contaminated to clean.

If, by contrast, the fluid were not dropped out of the wash chamber, the contamination contained within it would be eliminated via a dilution mechanism as the solvent flows from the wash chamber to the overflow chamber resulting in exponential contaminant decay with regard to the wash chamber as shown in Equation 2 (assuming instantaneous homogeneity of the fluid in the wash chamber as clean solvent is pumped in).

$${C}_{t} = \{ \begin{matrix}{C}_{0} ; t < {t}_{0} \\ Rs + ( {C}_{0} - Rs ) \times {e}^{- ( \frac{SFR \times t}{CV} )} ; t \geq {t}_{0}\end{matrix} \} \qquad Equation 2$$

where C₀=the contaminant concentration in the wash chamber immediately after dispensation from the dirty syringe; Cₜ=the contaminant concentration in the wash chamber at time=t; Rs=the residual contaminant concentration after the drop out, which results mostly from desorption of analyte previously adsorbed to the walls; t=time; t₀=the point where the drop-out valve is opened; SRF=solvent flow rate; and CV=wash chamber volume.

Contaminants would be only partially removed from the wash chamber in any reasonable time allotted between the syringe's dispense step and its next aspiration step. The syringe would subsequently draw partially contaminated solvent back into itself during the aspiration step. In this case, the rate of change-over from contaminated to clean is determined by both the flow rate of the incoming clean solvent and the volume of the wash chamber with the wash chamber's volume being the “time constant” of the exponential. The extent of change over (i.e. final cleanliness of the solvent in the wash chamber) is dependent on the initial contamination concentration in the cylinder and the time allotted between dispensing and aspirating the syringe for a given cylinder volume and solvent flow rate. In order to obtain roughly six orders of magnitude dilution for each dispense/aspirate cycle, approximately fourteen cylinder volumes (time constants) would need to be pumped through the cylinder. In practical terms this approach requires multiple times the solvent volume and takes substantially longer to reach a similar level of cleanliness than the fluid drop out approach described above. Clearly for time, solvent conservation, and overall efficiency, the solvent drop-out method is preferable to the dilution method for use in the syringe cleaning device, although the subject wash station could alternatively be used to perform a dilution procedure should this be desired for some reason.

Under laminar flow conditions, the time to remove the contaminated solvent from the wash chamber is dependent on the effective inner radius of the drain passage, the length of the drain passage, the viscosity of the liquid being evacuated, and the pressure drop across the drain passage. For minimum evacuation time while relying on gravity to provide the pressure drop, the effective inner radius of the drain passage could generally match the inner radius of the wash chamber and the drain passage could be kept short. If this is not practical, one can achieve a desired evacuation rate by applying a suction pump to the outlet end of the drain, thereby increasing the pressure drop from inside the wash chamber to the waste container.

As seen in FIG. 5, the wash chamber drain 24 opens to the needle wash chamber 18 below the wash port, and the wash port opens to the side wall of the needle wash chamber below the upper rim 33 of the needle wash chamber. The wash port may be located near the bottom of the wash chamber as shown, and thus at a location lower than the bottom end of the syringe needle when the latter is inserted and held in the wash chamber. Alternatively and/or additionally, a wash port may be located centrally of the wash chamber, or near or at the top of the wash chamber, or even above the rim of the wash chamber.

Also, the needle wash chamber 18 has a diameter greater than that of the needle 13 so as to define an annular space around the needle. The wash chamber diameter may be, for example, at least twice, three times or more than the diameter of the needle.

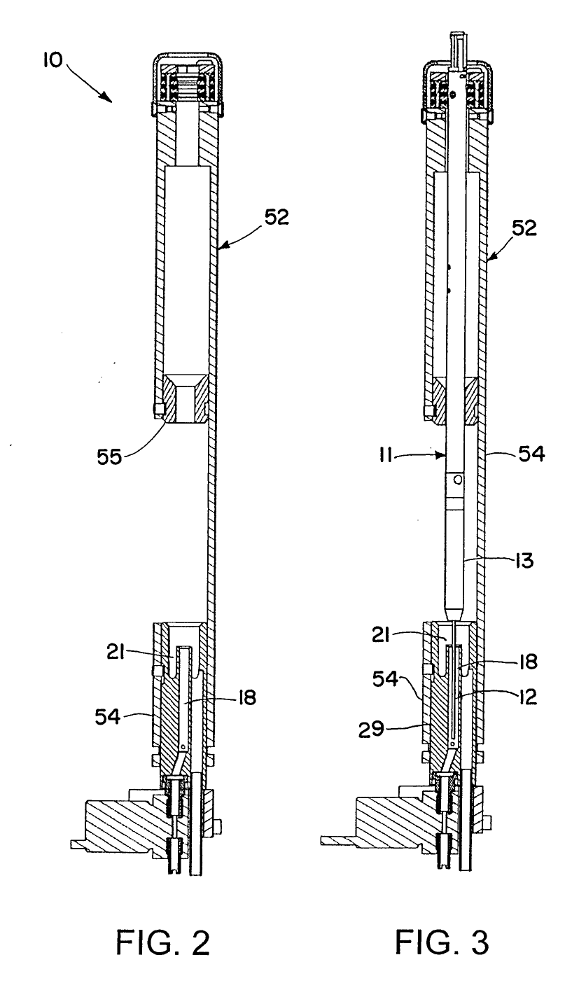

Referring back to FIGS. 2 and 3, the wash station further comprises a holder 52 for holding the syringe 11 with the needle 13 thereof inserted into the needle wash chamber 18. The illustrated holder is in the form of a tower, with the wash station body 29 containing the wash chamber 18 and overflow chamber 21 being located at the bottom of the tower. As shown, the wash chamber body may be secured within a tubular or block portion 54 at the lower end of the tower, that in turn is connected to the valve housing 28. An upright portion 54 of the tower 52 may support an intermediate guide and support member 55 between the wash chamber body 29 and the upper end of the tower.

As shown in FIG. 3, the upper end of the syringe 11 may project from upper end of the tower for gripping by a gripper, gantry mechanism or the like (not shown) that may be used to move the syringe into and out of the holder. In other systems, the syringe can be manually or otherwise inserted and removed from the wash station. The syringe may be axially inserted by a robotic device or otherwise into the syringe holder 52 until the injection needle is positioned as above described in the wash chamber 18. The syringe may be provided with a suitable stop for limiting such insertion movement to avoid over-insertion.

The holder 52 may also include a syringe interface device 58 for establishing communication between the syringe wash device 10 and the syringe 11, whereby commands can be received from the syringe or issued to the syringe from or to a wash station controller and/or overall system controller. In this manner, the motor or other motive device in the syringe that effects movement of the plunger can be controlled by the controller 31. Of course, other means may be employed to extend and retract the plunger, including manual means such a plunger extension extending from an end of the syringe where it can be manually manipulated to effect operation of the plunger.

In the illustrated exemplary embodiment, the interface device 58 provides for communication with and/or supplying power to the syringe 11. For further details of the interface device 58 and corresponding connection module of the syringe 11, and their manner of interfacing with one another and with control components and functional stations of an analytical system or systems, such as the herein described wash station, reference may be had to International Patent Application No. PCT/US06/02845 which is hereby incorporated herein by reference. By way of a specific example, a wash procedure may be effected under the control of the syringe 11 that may include a suitably programmed logic control device. The interface device 58 may also provide power to the syringe 11 when held in the wash station 10. It is noted, however, that other types of syringes may be used with the wash station device, including syringes that are inserted manually as well as those used by conventional liquid and sample handling systems wherein the syringe may be tethered to a gantry system or otherwise configured.

The syringe 11 may also be equipped with a locating device 60, such as a pin, that acts as a locating key for proper vertical and/or rotational registry of the syringe in the holder. The locating pin can seat in a locating slot at the top of the holder. The locating key may be used to limit the extent to which the syringe can be inserted axially (vertically) into the holder 52, or other means can be employed to limit the extent of insertion.

As above-mentioned, the syringe 11 can be operated for aspirating and/or dispensing a cleaning fluid. The syringe may be self-contained thereby eliminating the need for a tether and thus reducing the complexity of coordinating the flow of the sampling syringes through the system. An untethered self-contained sampling syringe typically would include the plunger and a motive device for moving the plunger in response to a command signal. The command signal may be effected wirelessly between the sampling syringe and a stationary system component, and/or by other suitable means.

The syringe 11 may be cylindrical over a major portion of its length. The maximum outer diameter of the syringe may be equal or less than 9 mm so that the sampling syringes can be ganged together or individually placed next to each other dynamically during operation as in a grid pattern at a 9 mm center-to-center spacing, or less. As will be appreciated, multiple wash stations can be arranged in an array for parallel servicing of multiple syringes. In particular, multiple wash stations 10 can be arranged in a row or grid, in side-by-side relationship.

In view of the foregoing description, it should now be apparent that the invention provides a wash station, particularly a stand-alone syringe wash station, capable of providing quick, preferably hands-free, fluidic service to syringes used in laboratory operations. The principles of the invention may be used with a variety of different types of syringes, including in particular the herein described syringe.

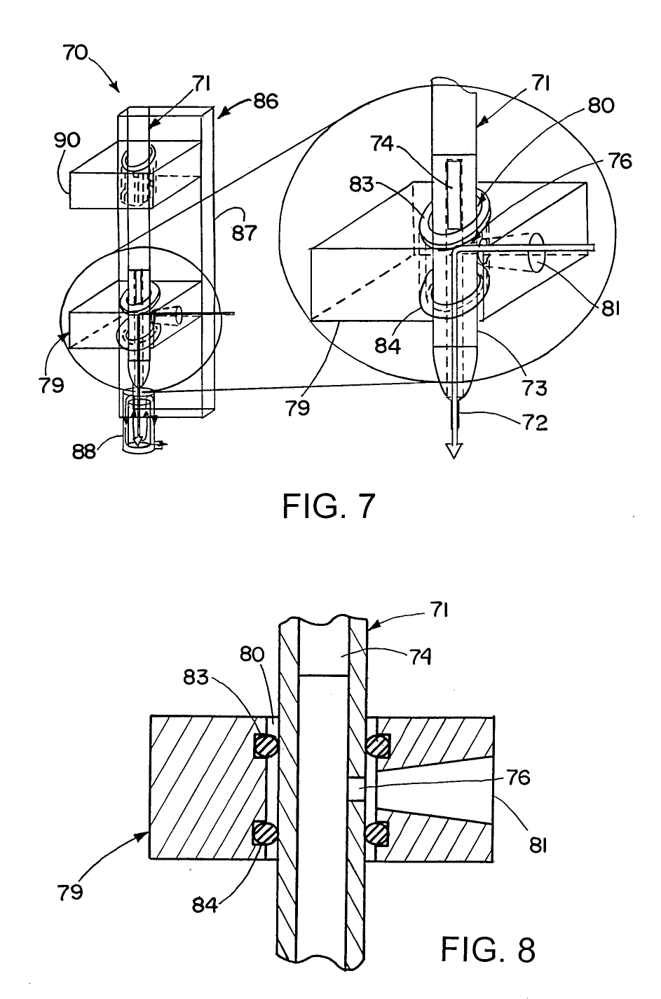

Referring now to FIGS. 7 and 8, another embodiment of stand-alone syringe wash station is indicated generally by reference number 70. The wash station 70 is intended for use with a syringe 71 including a needle 72 communicating with a barrel 73 in which a plunger 74 is movable for dispensing or aspirating a fluid through a distal open end of the needle, and a side port 76 communicating with the barrel 73, particularly at an upper portion of the barrel. The above description of the syringe 11 is equally applicable to the syringe 71. Although not mentioned above, the syringe 11 may also have a side port 76 although the above-described exemplary method does not utilize the side port. The provision of a side port, however, allows the syringe 11, the syringe 71 and other syringes to be cleaned in the wash station device 70 or similar device according to the present invention.

The syringe wash station 70 comprises a body 79 including an axially extending interior chamber 80 into which the syringe can be axially inserted, and a wash port 81 opening to the interior chamber, in particular to a side wall of the interior chamber, for supplying a cleaning fluid to the interior chamber. A pair of axially spaced apart annular seals 83 and 84, which may be O-ring seals as shown, are located on opposite sides of the wash port 81 for sealing against an exterior, preferably cylindrical, surface of the syringe 71 at opposite sides of the side port 76 of the syringe.

A suitable holder 86, which may be similar to that described above, may be provided to hold the syringe 71 in place during a cleaning operation. As shown, the holder 86 may include an upright 87 extending upwardly from a fluid receptacle 88 that may be supported by the upright at its lower end, or vice versa. The upright 87 support the body 79 above the fluid receptacle so that it will align with the side port 74 of the syringe when the syringe is fully inserted into the holder 87 with the needle properly positioned relative to the fluid receptacle, such as within the fluid receptacle so the needle can be immersed in cleaning fluid contained in the receptacle to clean the exterior of the needle, in particular a lower portion of the needle. The holder may further include a syringe guide and support member 90 on the holder to guide the syringe during insertion and support the syringe in the holder. The guide and support member may be spaced above the body 79 a desired distance so that the syringe will be held in a stable manner, although other means may also be employed.

The supply of fluid to the wash port 81, and to and from the receptacle 88 can be effected in a manner similar to that described above. That is, the flow of fluid to the wash port 81 may be controlled by a suitable valve and/or pump that in turn may be controlled by a suitable controller, such as a wash station controller. Alternatively or additionally, the supply of fluid may be controlled manually such as by use of a manually operated valve. In addition, fluid can be supplied to the receptacle 88 by a suitable valve and/or pump controlled by a controller, such as the wash station controller; and fluid can be drained from the receptacle 88 via a drain provided with a valve for opening and closing the drain, such as that shown above. The drain can be closed to cause the receptacle to fill for cleaning of the exterior surface of the needle. The receptacle may be configured similarly to the above-described wash and overflow chambers if desired.

An exemplary method of cleaning the syringe 71 using the wash station 70 comprises the steps of axially inserting the syringe into the axially extending interior chamber 83 of the wash station with the side port 71 located in a region bounded by the pair of annular seals 83 and 84. The plunger is then retracted so that it is located on a side of the side port remote from the distal open end of the needle 72. Cleaning fluid is then supplied from a source thereof to the wash port for flow into the interior chamber, whereupon such fluid will flow through the side port into the barrel of the syringe and out through the distal end of the needle, thereby cleaning interior surfaces of the syringe.

Thus, the wash station 70 provides a quick, preferably hands-free connect and release, fluidic service to “fast-wash” syringes used in laboratory operations. The two annular fluidic seals 83 and 84 form the top and bottom seals respectively around the syringe body. The syringe body itself forms the inner wall of the wash cavity while the structure supporting the annular fluidic seals serves as the outer wash wall. An open fluidic path is established extending from a remote pumping mechanism, through the outer wash wall, through the side port of the syringe, into the barrel, and out through the open end of the syringe probe.

As will be appreciated the foregoing description, the syringe 71 does not need a dedicated wash line connected to it, thereby eliminating the proclivity for tangling and leaking as with existing designs. The system is rotationally isotropic with respect to the azimuthal orientation of the syringe within the wash station. The wash station can be small and modular, and can reside easily on a robotic device as well as be placed on a laboratory bench or wherever it is convenient for use. Several wash stations can be grouped or ganged together to create a pool of syringes each at a different stage of cleaning but always providing at least one clean device at any given instant.

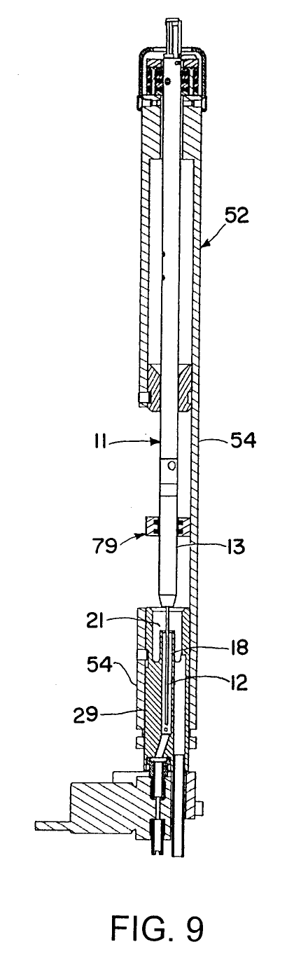

Features of the above-described wash stations 10 and 70 can be combined to provide a single universal wash station that can service syringes that have or don't have a side port. As illustrated in FIG. 9, the body 79 of the wash station 70 can be mounted to the upright portion 54 of the tower 52 above the wash chamber 18. Consequently, the interior of a syringe provided with a side port can be washed using procedures similar to those described above in relation to the wash station 70, or alternatively or additionally the interior of the syringe can be washed in a manner similar to that described above in relation to the wash station 10. If a syringe is not provided with a side port, it can be washed in a manner similar to that described above in relation to the wash station 10. In all cases, the exterior of the syringe can be washed by flowing cleaning fluid through the wash chamber 18.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A syringe wash station for cleaning a syringe used in a liquid handling system or to perform liquid handling operations, the syringe including a needle communicating with a barrel in which a plunger is movable for dispensing or aspirating a fluid through a distal open end of the needle, comprising:
an interior needle wash chamber having a lower end and an open upper end into which the needle of the syringe can be axially inserted;
an overflow chamber extending vertically above the open upper end of the needle wash chamber;
a wash port opening to a side wall of the needle wash chamber for supplying a cleaning fluid to the interior chamber;
a drain connected to the lower end of the needle wash chamber;
a valve for opening and closing the drain respectively to permit and block fluid flow through the drain, whereby when the valve is closed fluid flowing from the wash port into the needle chamber can fill the needle wash chamber and overflow the upper end of the needle wash chamber for flow into the overflow chamber, and when the valve is open cleaning fluid can flow from the needle wash chamber through the drain; and
a wash station controller for
(a) flowing cleaning fluid through the wash port opening in a side wall of the needle wash chamber between upper and lower ends of the needle wash chamber after the syringe has been axially inserted through the open upper end of the needle wash chamber;
(b) closing the drain to cause cleaning fluid to fill the needle wash chamber and flow out through the open upper end of the needle wash chamber into the overflow chamber;
(c) opening the drain to allow the cleaning fluid in the needle wash chamber to flow out through a drain;
(d) retracting the plunger of the syringe during step (b) to draw cleaning fluid through the needle and into the barrel of the syringe; and
(e) extending the plunger of the syringe during step (c) to discharge the cleaning fluid from the barrel of the syringe through the needle and into the fluid flowing from the needle wash chamber to the drain.

2. A syringe wash station according to claim 1, wherein the drain opens to the needle wash chamber below the wash port, and the wash port opens to the side wall of the needle wash chamber below the upper end of the needle wash chamber.

3. A syringe wash station according to claim 1, wherein the needle wash chamber is formed by a first tubular member, and the overflow chamber is formed between the first tubular member and a larger diameter second tubular member that surrounds but is radially spaced from the first tubular member.

4. A syringe wash station according to claim 1, in combination with the syringe, wherein the needle wash chamber has a diameter at least twice the diameter of the needle.

5. A syringe wash station according to claim 1, further comprising a holder for holding the syringe with the needle thereof inserted into the needle wash chamber.

6. A syringe wash station according to claim 5, wherein the holder includes a syringe interface device for establishing communication between the wash station controller and the syringe, whereby commands can be received from the syringe or issued to the syringe by or from the wash station controller.

7. A syringe wash station according to claim 1, further comprising a body defining an axially extending interior chamber into which the syringe can be axially inserted, and a wash port opening to a side wall of the interior chamber for supplying a cleaning fluid to the interior chamber; and a pair of annular seals axially spaced apart and located on opposite side of the wash port for sealing against an exterior surface of the syringe at opposite sides of a side port of the syringe.

8. A method of cleaning a syringe used in a liquid handling system or to perform liquid handling operations, wherein the syringe includes a needle communicating with a barrel in which a plunger is movable for dispensing or aspirating a fluid through a distal open end of the needle, the method comprising the steps of:
(a) axially inserting the syringe through an open upper end of an axially extending needle wash chamber at a wash station;
(b) flowing cleaning fluid through a wash port opening in a side wall of the needle wash chamber between upper and lower ends of the needle wash chamber;
(c) closing the drain to cause cleaning fluid to fill the needle wash chamber and flow out through an open upper end of the needle wash chamber into an overflow chamber;
(d) opening the drain to allow the cleaning fluid in the needle wash chamber to flow out through a drain;
(e) retracting the plunger of the syringe during step (c) to draw cleaning fluid through the needle and into the barrel of the syringe; and
(f) extending the plunger of the syringe during step (d) to discharge the cleaning fluid from the barrel of the syringe through the needle and into the fluid flowing from the needle wash chamber to the drain.

9. A method according to claim 8, wherein the cleaning fluid drains by gravity through the drain when the valve is open.

10. A method according to claim 8, wherein steps (b) through (f) are repeated multiple times.

11. A method according to claim 8, wherein at least 20% of the length of the needle is inserted into the needle wash chamber.

12. A method according to claim 8, wherein at least 50% of the length of the needle is inserted into the needle wash chamber.

13. A method according to claim 8, wherein the needle is held spaced from the side wall of the needle wash chamber when inserted into the wash chamber.

14. A syringe wash station for cleaning a syringe used in a liquid handling system or to perform liquid handling operations, the syringe including a needle communicating with a barrel in which a plunger is movable for dispensing or aspirating a fluid through a distal open end of the needle, and a side port communicating with the barrel, the syringe wash station comprising:
a body defining an axially extending interior chamber into which the syringe can be axially inserted, and a wash port opening to a side wall of the interior chamber for supplying a cleaning fluid to the interior chamber; and
a pair of annular seals axially spaced apart and located on opposite side of the wash port for sealing against an exterior surface of the syringe at opposite sides of the side port of the syringe.

15. A syringe wash station according to claim 14, further comprising a holder for receiving and holding the syringe such that the side port of the syringe will be located in the region of the interior chamber located between the annular seals.

16. A method of cleaning a syringe used in a liquid handling system or to perform liquid handling operations, wherein the syringe includes a needle communicating with a barrel in which a plunger is movable for dispensing or aspirating a fluid through a distal open end of the needle, and a side port communicating with the barrel, the method comprising the steps of:
axially inserting the syringe into an axially extending interior chamber of a wash station with the side port located in a region bounded by a pair of annular seals axially spaced apart and located on opposite sides of a wash port for sealing against an exterior surface of the syringe at opposite sides of the wash port;
retracting the plunger of the syringe such that the plunger is located on a side of the side port remote from the distal end of the needle; and
flowing a cleaning fluid through the wash port and into the interior chamber, whereupon such fluid will flow through the side port into the barrel of the syringe and out through the distal end of the needle, thereby cleaning interior surfaces of the syringe.
